(19) United States
(12) Patent Application Publication
(10) Pub. No.: US 2019/0008123 A1
(43) Pub. Date: Jan. 10, 2019

(54) Anti mating apron

(71) Applicants: Ronald Eugene Kalna, JR., Rye, CO (US); June Marie McLean, Rye, CO (US)

(72) Inventors: Ronald Eugene Kalna, JR., Rye, CO (US); June Marie McLean, Rye, CO (US)

(21) Appl. No.: 15/731,616

(22) Filed: Jul. 7, 2017

(51) Int. Cl. A01K 21/00; A01K 13/00

(52) U.S. Cl. CPC A01K 21/00; A41D 13/04; A01K 13/006

(57) ABSTRACT

The anti mating apron controls unwanted breeding of small ruminant livestock. The anti mating apron blocks the male's reproductive organ so that he is unable to penetrate the female. The anti mating apron is strapped to the body of the male livestock around the girth. The anti mating apron is clipped into place by a single side adjust plastic buckle and adjusted to fit snug but not tight. The anti mating apron is weighted with bbs that are sewn into the bottom of the anti mating apron. The weights of the anti mating apron keep the apron in place and generally doesn't allow the apron to get stuck to one side of the animal.

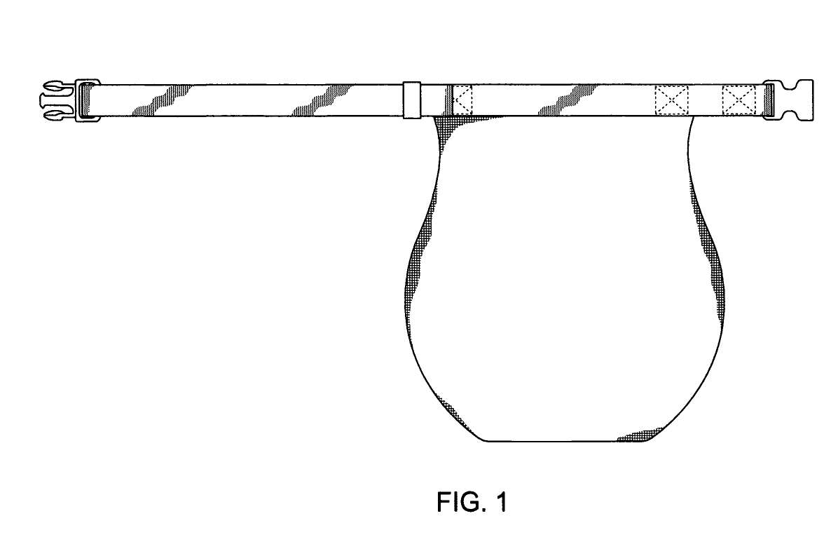

The present invention is used to provide a safe method of preventing unwanted breeding in small ruminant livestock while allowing the male to cohabitate with the herd and prevent young livestock from breeding with siblings and their own mother.

The Bacchus Johnson Shield is an anti-breeding shield for intact male goats. The Shield prevents unwanted breeding by blocking the male's ability to penetrate the female and helps control urine scald. The Bacchus Johnson Shield simply straps around the chest of the goat and stays secured for as long as needed. It's weighted in the middle and will center itself on the goat's body as it moves. When the goat mounts a female the shield acts as a barrier. In rutting season the male goat (Buck) will ejaculate and urinate on his face and legs to entice the female to mate. The shield blocks bodily fluids that would settle on the face and legs where the acid from the urine would burn the skin and cause scalding. The shield helps control the scalding.

Made from double layered, strong, water resistant Nylon material (Cordura), a 1″ Nylon strap and a 1″ heavy duty plastic snap with a 1″ plastic keeper. Weights (BBs) are sewn in their own pouch and then sewn into the shield so that it sits in the middle allowing the loosely snapped shield to keep centered on the goat.

1. Two pre-cut pieces of fabric comprised of Cordura Nylon, having a bell-shaped appearance of the body and a squared shape at the bottom. Wherein said fabric is sewn inside out along edge leaving top open.

2. A squared piece of fabric comprised of Cordura Nylon is cut and sewn along all edges except one, wherein metal bbs are funneled into and then sewn along open edge.

3. The invention of claim 2 is then inserted into square section of claim 1 then sewn in semi circle from bottom edge along top of claim 2 to opposite edge.

4. The invention of claim 1 is then pulled outside in and top section is tucked and pinned in place.

5. A certain length (varies with size) of strap comprised of Nylon is cut and plastic single side adjust buckle is sewn onto single end of said strap.

6. The invention of claim 5 is then sewn along edges onto the top of the invention of claim 1. Cross stitched at each end for strength.

7. The invention of claim 5 is then inserted into opposite end of single side adjust plastic buckle so that said buckle may be adjusted to fit the body of the small ruminant livestock male.
